(19) United States
(12) Patent Application Publication
(10) Pub. No.: US 2011/0149301 A1
(43) Pub. Date: Jun. 23, 2011

(54) Beam position measuring apparatus and method

(75) Inventors: Oui Serg Kim, Seongnam-si (KR); Vladimir Protopopov, Suwon-si (KR); Dong Seok Baek, Suwon-si (KR)

(73) Assignee: Samsung Electronics Co., Ltd.

(21) Appl. No.: 12/926,880

(22) Filed: Dec. 15, 2010

(30) Foreign Application Priority Data
Dec. 23, 2009 (KR) 10-2009-0129642

(51) Int. Cl. G01B 11/14

(52) U.S. Cl. 356/622

(57) ABSTRACT

A beam position measuring apparatus and method using a beam expansion device may expand areas of beams irradiated onto a beam detection sensor. The beam expansion device is configured to expand areas of the beams onto the beam detection sensor is installed between a beam generator and the beam detection sensor. Central positions of the irradiated beams are detected using intensities of beams irradiated onto respective pixels of the beam detection sensor.

### CROSS-REFERENCE TO RELATED APPLICATION

This application claims priority under 35 U.S.C. §119 to Korean Patent Application No. 2009-0129642, filed on Dec. 23, 2009 in the Korean Intellectual Property Office (KIPO), the entire contents of which are incorporated herein by reference.

### BACKGROUND

1. Field

Example embodiments of the present invention relate to an apparatus and method of measuring central positions of beams irradiating from a multi-beam generator.

2. Description of the Related Art

Exposure apparatuses are widely used in a semiconductor fabricating process. In general, an exposure apparatus exposes a desired pattern on a wafer or a glass substrate using a mask. However, if the mask is used, the mask incurs expenses and generates sagging of a substrate due to large-scale of the substrate. Therefore, maskless exposure apparatuses using a spatial light modulator (SLM), such as a digital micro-mirror device (DMD), have become popular. A maskless exposure apparatus is operated in a method using a virtual mask in which light is irradiated onto an SLM to switch on and off micro-mirrors corresponding to a desired pattern. In order to make the virtual mask, it may be desirable to detect accurate positions at which beams reflected by the micro-mirrors are irradiated onto a glass substrate.

In order to detect positions of beams in the exposure apparatus irradiating multiple beams, an expansion optical system may be used. Beams are expanded through the expansion optical system, and irradiated onto the surface of a detection sensor, which is an image sensor, such as a CCD sensor or a CMOS sensor, and central positions of the beams are detected using intensities of the beams measured at respective pixels of the image sensor. Measurement of the central positions of the beams may be achieved as follows. On the assumption that an intensity of a beam has a Gaussian distribution, a size of the beam is defined as a full width at half maximum (FWHM). The FWHM is defined as the width of the beam at half of the maximum intensity of the beam having the Gaussian distribution, and the central position of the beam size is calculated from the FWHM. Here, when the beam is expanded using the expansion optical system, the number of pixels of the image sensor corresponding to the expanded beam is increased, and position data from many pixels are used. However, as the beam is expanded, the number of beams measured in the same area of the image sensor is decreased and thus time to measure all the beams is rapidly increased proportionally.

### SUMMARY

Therefore, example embodiments of the present invention may provide a beam position measuring apparatus and method using a beam expansion device which expands areas of respective beams irradiated onto a beam detection sensor while maintaining intervals between the respective beams.

In accordance with one aspect of the present invention, a beam position measuring apparatus may include a beam detection sensor, a beam generator configured to irradiate a plurality beams onto the beam detection sensor, and a beam expansion device located between the beam generator and the beam detection sensor configured to expand areas of the beams irradiated onto the beam detection sensor while maintaining intervals between the plurality of beams.

The beam expansion device may be a diffraction device configured to diffract the plurality beams irradiated from the beam generator, or be a scattering device to scatter the beams irradiated from the beam generator.

The diffraction device may be an ultrasonic generator configured to irradiate ultrasonic waves to diffract the plurality of beams irradiated from the beam generator, or be a diffractive optical element to diffract the beams irradiated from the beam generator.

The diffraction device may be a diffractive optical element configured to diffract the plurality of beams irradiated from the beam generator.

The beam expansion device may be a scattering device configured to scatter the plurality of beams irradiated from the beam generator.

The beam generator may be configured to use a laser or a laser diode as a light source, and irradiate at least one beam using a spatial light modulator.

The beam detection sensor may be a CMOS sensor or a CCD sensor.

In accordance with another aspect of the present invention, a beam position measuring method using a beam generator and a beam detection sensor includes allowing a plurality of beams irradiated from the beam generator to pass through a beam expansion device so as to expand areas of the beam while maintaining intervals between the plurality of beams and then irradiating the plurality of beams having the expanded areas onto the beam detection sensor, measuring intensities of the plurality of beams irradiated onto respective pixels of the beam detection sensor, and detecting central positions of the plurality of beams by calculating centers of distributions of the measured intensities of the plurality of beams.

The beam expansion device may be a diffraction device to diffract the beams irradiated from the beam generator, or be a scattering device to scatter the plurality of beams irradiated from the beam generator.

The diffraction device may be an ultrasonic generator to irradiate ultrasonic waves to diffract the plurality of beams irradiated from the beam generator, or be a diffractive optical element to diffract the plurality of beams irradiated from the beam generator.

The diffraction device may be a diffractive optical element to diffract the plurality of beams irradiated from the beam generator.

The beam generator may use a laser or a laser diode as a light source, and irradiate at least one beam using a spatial light modulator.

The beam expansion device may be a scattering device to scatter the plurality of beams irradiated from the beam generator.

The beam detection sensor may be a CMOS sensor or a CCD sensor.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a view illustrating a schematic configuration of a beam position measuring apparatus in accordance with example embodiments of the present invention;

FIG. 2 is a view illustrating a beam position measuring apparatus using an ultrasonic generator in accordance with example embodiments of the present invention;

FIG. 3 is a view illustrating a beam position measuring apparatus using a diffractive optical element in accordance with example embodiments of the present invention;

FIG. 4(a) and FIG. 4(b) are views illustrating shapes of beams irradiated onto a beam detection sensor when diffraction is not generated and when diffraction is generated, respectively;

FIG. 5 is a view illustrating a beam position measuring apparatus using a scattering device in accordance with example embodiments of the present invention;

FIG. 6(a) and FIG. 6(b) are views illustrating surface scattering and internal scattering of the scattering device, respectively;

FIG. 7(a) and FIG. 7(b) are views illustrating shapes of beams irradiated onto the beam detection sensor when scattering is not generated and when scattering is generated, respectively; and

FIG. 8 is a flow chart illustrating a beam position measuring method in accordance with example embodiments of the present invention.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

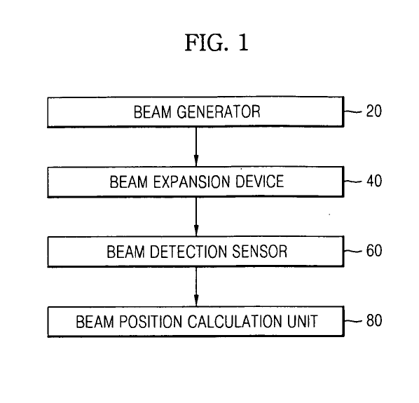

FIG. 1 is a view illustrating a schematic configuration of a beam position measuring apparatus in accordance with example embodiments of the present invention. The beam measuring apparatus includes a beam generator 20, a beam expansion device 40, a beam detection sensor 60, and a beam position calculation unit 80.

The beam generator 20 may include, for example, a light source, an illumination optical system, and a projection optical system, which are not shown in the drawings. Examples of a light source may be used in the beam generator 20 include a laser, and a laser diode. When the light source of the beam generator 20 generates a beam, the beam is modulated into at least one beam formed in a desired pattern by, for example, a spatial light modulator (SPL). The beam passes through the illumination optical system and the projection optical system, and is irradiated onto the beam detection sensor 60 through the beam expansion device 40.

The beam expansion device 40 serves to expand the area of the beam irradiated from the beam generator 20 and then to irradiate the expanded beam onto the surface of the beam detection sensor 60. A device using, for example, diffraction or scattering may be used as the beam expansion device 40, and a detailed configuration thereof will be described later.

The beam detection sensor 60 serves to detect the beam expanded through the beam expansion device 40. An image sensor, for example a CCD sensor or a CMOS sensor, may be used as the beam detection sensor 60.

The beam position calculation unit 80 serves to calculate the central position of the beam using the intensity of the beam detected at the surface of the image sensor, for example a CCD sensor or a CMOS sensor. On the assumption that an intensity of a beam has a Gaussian distribution, a size of the beam may be defined as, for example, a full width at half maximum (FWHM). The FWHM is defined as the width of the beams at half of the maximum intensity of the beam having the Gaussian distribution, and the central position of the beam size is calculated from the FWHM.

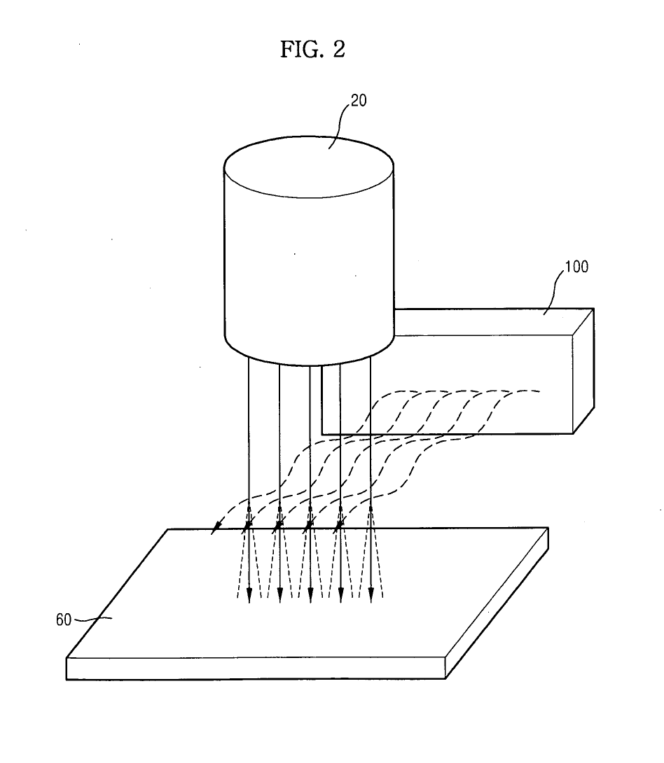

Hereinafter, a beam position measuring apparatus and method using diffraction or scattering will be described in detail with reference to FIGS. 2 to 8.

FIG. 2 is a view illustrating a beam position measuring apparatus using an ultrasonic generator 100 in accordance with example embodiments of the present invention. As is illustrated in FIG. 2, a beam position measuring apparatus in accordance with example embodiments may include a beam generator 20, the ultrasonic generator 100, and a beam detection sensor 60.

The ultrasonic generator 100 generates ultrasonic waves in a direction orthogonal to beams irradiated from the beam generator 20, and serves to expand the beams by means of diffraction generated by interference between the beams and the ultrasonic waves. From FIG. 2, it may be seen that the beams irradiated from the beam generator 20 are diffracted by interference with the ultrasonic waves generated from the ultrasonic generator 100, and then are irradiated onto the beam detection sensor 60. Through such a configuration, the beams to be irradiated onto the beam detection sensor 60 are expanded.

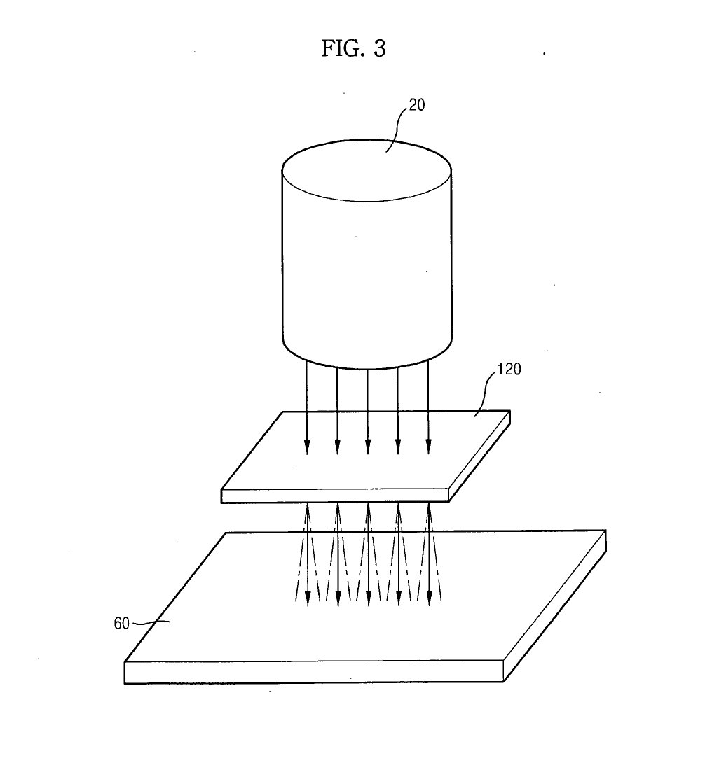

FIG. 3 is a view illustrating a beam position measuring apparatus using a diffractive optical element 120 in accordance with example embodiments of the present invention. As is illustrated in FIG. 3, a beam position measuring apparatus in accordance with this embodiment may include a beam generator 20, the diffractive optical element 120, and a beam detection sensor 60.

The diffractive optical element 120 serves to allow beams irradiated from the beam generator 20 to be diffracted and then be irradiated onto the surface of the beam detection sensor 60. A flat plate including a slit may be used as the diffractive optical element 120. From FIG. 3, it may be seen that the beams irradiated from the beam generator 20 are diffracted by the diffractive optical element 120, and then are irradiated onto the beam detection sensor 60. Through such a configuration, the beams to be irradiated onto the beam detection sensor 60 are expanded.

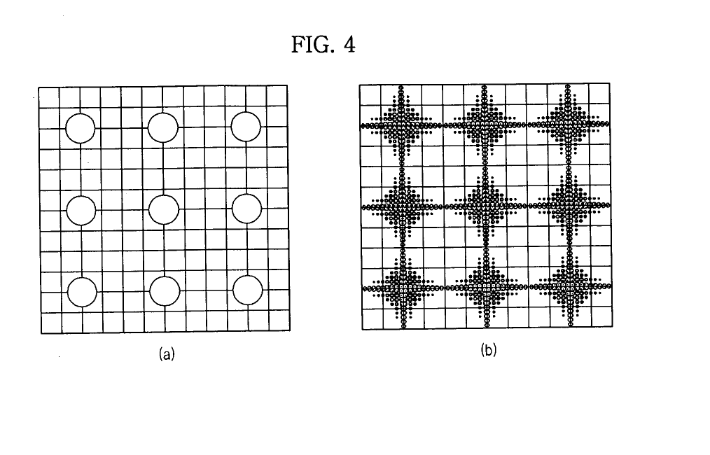

FIG. 4(a) and FIG. 4(b) are views illustrating shapes of beams irradiated onto the beam detection sensor when diffraction is not generated and when diffraction is generated, respectively.

FIG. 4(a) is a view illustrating an example of a shape of beams irradiated onto the surface of the beam detection sensor 60 when diffraction is not generated. From FIG. 4(a), it may be confirmed that a total of 9 beams are measured and one beam occupies 4 pixels. Therefore, a relation of number of pixels/beams=4 may be derived. The obtained value of the number of the pixels per beam relates to calculation accuracy of central positions of the beams, and a detailed description thereof will be given later.

FIG. 4(b) is a view illustrating an example of a shape of beams irradiated onto the surface of the beam detection sensor 60 when diffraction is generated. From FIG. 4(b), it may be confirmed that a total of 9 beams are measured and one beam occupies 16 pixels. Therefore, a relation of number of pixels/beams=16 may be derived. Hereinafter, cases of FIG. 4(a) and FIG. 4(b) will be comparatively described.

FIG. 4(a) illustrates the shape of the beams irradiated onto the surface of the beam detection sensor 60 if no expansion optical system is used, and in this case, the number of the beams measured at the surface of the beam detection sensor 60 is larger than the number of the beams if an expansion optical system is used. Accordingly, if the expansion optical system, such as a microscope, is used, one or two beams are expanded and measured and the number of pixels occupied by one beam is increased. This means that the number of beams measured at a time is small and thus it takes long time to calculate central positions of beams, but the number of pixels occupied by one beam is increased and thus calculation accuracy of the central positions of the beams is improved. In the case of the FIG. 4(a), since no expansion optical system is used, the number of the beams measured at the surface of the beam detection sensor 60 is increased but the number of pixels occupied by one beam is decreased, and thus calculation accuracy of the central positions of the beams is considerably lowered.

However, FIG. 4(b) illustrates an example of the shape of the beams irradiated onto the surface of the beam detection sensor 60 if the expansion optical system according to example embodiments of the present invention is used. From FIG. 4(b), it may be confirmed that the number of the beams measured at the surface of the beam detection sensor 60 is equal to that of FIG. 4(a), but the number of pixels occupied by one beam is increased. Accordingly, it may be confirmed that since greater pixel data are used to calculate the central position of one beam, calculation accuracy of the central positions of the beams is raised.

As described above, if the expansion optical system, such as a microscope, is used, the number of pixels occupied by one beam is increased and thus calculation accuracy of beam central position is improved, but the number of beams measured at a time is remarkably reduced and thus it takes long time to detect central positions of all beams. If the expansion optical system is used, a surface, onto which the beams are irradiated is entirely expanded, and thus an area occupied by the beams and intervals between the beams are simultaneously expanded.

However, as shown in FIG. 4(b), if the beam expansion device 40 is used, the number of pixels occupied by one beam is increased and the number of the beams measured at a time is maintained, thereby being capable of improving a central position detecting speed while maintaining calculation accuracy of beam central position. The beam expansion device 40 maintains the intervals between the beams, and increases the number of pixels occupied by the respective beams.

Here, the calculation of the central positions of the beams is achieved by the FWHM, as described above.

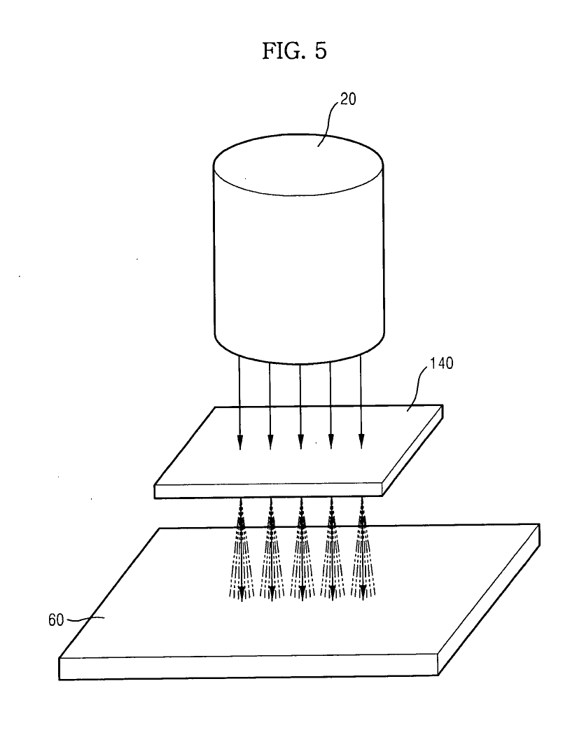

FIG. 5 is a view illustrating a beam position measuring apparatus using a scattering device 140 in accordance with example embodiments of the present invention. As FIG. 5 illustrates, a beam position measuring apparatus in accordance with example embodiments may include a beam generator 20, the scattering device 140, and a beam detection sensor 60.

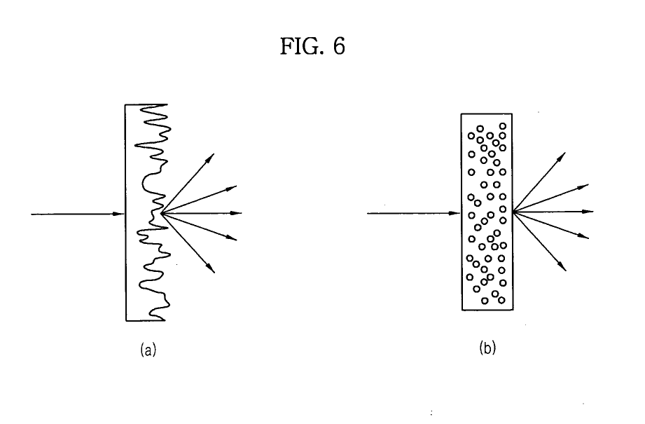

The scattering device 140 serves to allow beams irradiated from the beam generator 20 to be scattered and then to be irradiated onto the surface of the beam detection sensor 60. Scattering refers to spreading of light all around when the light collides with small particles, and is classified into surface scattering and internal scattering. FIG. 6(a) and FIG. 6(b) respectively illustrate examples of surface scattering and internal scattering. FIG. 6(a) is a view illustrating an example of surface scattering in which irradiated beams are scattered all around by an uneven surface. FIG. 6(b) is a view illustrating an example of internal scattering in which irradiated beams are scattered all around by uniformly distributed internal particles. From FIG. 5, it may be seen that the beams irradiated from the beam generator 20 are scattered by the scattering device 140, and then irradiated onto the beam detection sensor 60. Through such a configuration, the beams to be irradiated onto the beam detection sensor 60 are expanded.

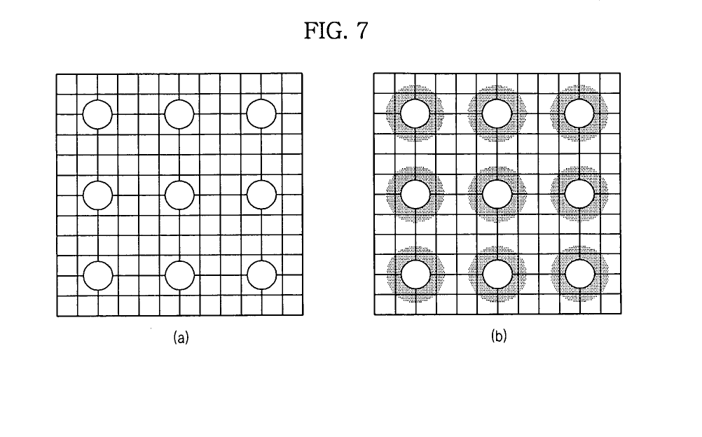

FIG. 7(a) and FIG. 7(b) are views illustrating example shapes of beams irradiated onto the beam detection sensor when scattering is not generated and when scattering is generated, respectively.

FIG. 7(a) is a view illustrating an example shape of beams irradiated onto the surface of the beam detection sensor 60 if the scattering device is not used. As FIG. 7(a) illustrates, the number of the beams measured at the surface of the beam detection sensor 60 is larger than the number of the beams if an expansion optical system is used. Accordingly, if the expansion optical system, such as a microscope, is used, one or two beams are expanded and measured and the number of pixels occupied by one beam is increased. This means that the number of beams measured at a time is small and thus it takes long time to calculate central positions of beams, but the number of pixels occupied by one beam is increased and thus calculation accuracy of the central positions of the beams is improved. In the case of the FIG. 7(a), since no expansion optical system is used, the number of the beams measured at the surface of the beam detection sensor 60 is increased but the number of pixels occupied by one beam is decreased, and thus calculation accuracy of the central positions of the beams is considerably lowered.

However, FIG. 7(b) illustrates an example of a shape of beams irradiated onto the surface of the beam detection sensor 60 if the scattering device 140 is used. From FIG. 7(b), if the scattering device 140 is used, it may be confirmed that the number of the beams measured at the surface of the beam detection sensor 60 is equal to that of FIG. 7(a), but the number of pixels occupied by one beam is increased. Accordingly, it may be confirmed that since greater pixel data are used to calculate the central position of one beam, and thus calculation accuracy of the central positions of the beams is raised.

As described above, the scattering device 140 increases the number of pixels occupied by one beam and maintains the number of beams measured at a time, thereby being capable of improving a central position detecting speed while maintaining calculation accuracy of beam central position.

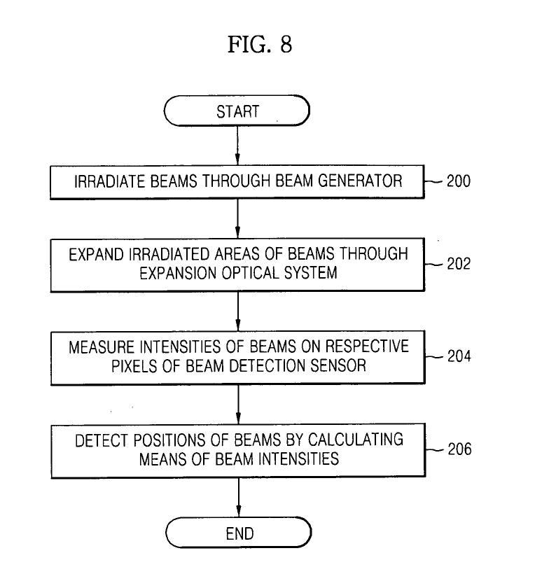

FIG. 8 is a flow chart illustrating a beam position measuring method in accordance with one embodiment of the present invention.

First, in operation 200 the beam generator 20 irradiates beams. Thereafter, in operation 202 irradiated areas of the beams are expanded by the beam expansion device 40 and then the beams are irradiated onto the surface of the beam detection sensor 60. Here, the beam expansion device 40 may be, for example, one of the above-described ultrasonic generator 100, diffractive optical element 120, and scattering device 140, and thus expand areas of the beams irradiated onto the surface of the beam detection sensor 60 using diffraction or scattering. In operation 204, the beam detection sensor 60 measures intensities of the beams irradiated onto respective pixels. In operation 206, the beam position calculation unit 80 detects central positions of the beams using the intensities of the beams irradiated onto the respective pixels.

By expanding areas of pixels of the sensor 60 occupied by the respective beams irradiated by the above-described beam position measuring apparatus and method while maintaining intervals between the respective beams, it may be possible to increase the number of beams to be measured while improving calculation accuracy of beam central position. according to example embodiments of the present invention, it may be possible to improve calculation accuracy of central positions of multiple beams and shorten measurement time, simultaneously.

As is apparent from the above description, a beam position measuring apparatus and method in accordance with one embodiment of the present invention expands areas of pixels of a beam detection sensor occupied by respective beams while maintaining intervals between the respective beams, thereby increasing the number of beams to be measured and improving beam central position calculation accuracy. According to example embodiments of the present invention, calculation accuracy of central positions of multiple beams is improved and measurement time is shortened, simultaneously.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A beam position measuring apparatus comprising:
a beam detection sensor;
a beam generator configured to irradiate a plurality of beams onto the beam detection sensor;
and
a beam expansion device located between the beam generator and the beam detection sensor, the beam expansion device being configured to expand areas of the plurality of beams irradiated onto the beam detection sensor while maintaining intervals between the plurality of beams.

2. The beam position measuring apparatus according to claim 1, wherein the beam expansion device is a diffraction device configured to diffract the plurality of beams irradiated from the beam generator.

3. The beam position measuring apparatus according to claim 2, wherein the diffraction device is an ultrasonic generator configured to irradiate ultrasonic waves to diffract the plurality of beams irradiated from the beam generator.

4. The beam position measuring apparatus according to claim 2, wherein the diffraction device is a diffractive optical element configured to diffract the plurality of beams irradiated from the beam generator.

5. The beam position measuring apparatus according to claim 1, wherein the beam expansion device is a scattering device configured to scatter the plurality of beams irradiated from the beam generator.

6. The beam position measuring apparatus according to claim 1, wherein the beam detection sensor is a CMOS sensor or a CCD sensor.

7. The beam position measuring apparatus according to claim 1, wherein the beam generator includes at least one of a laser and a laser diode.

8. A beam position measuring method using a beam generator and a beam detection sensor, the method comprising:
allowing a plurality of beams irradiated from the beam generator to pass through a beam expansion device so as to expand areas of the plurality of beams while maintaining intervals between the plurality of beams, and then irradiating the plurality of beams having the expanded areas onto the beam detection sensor;
measuring intensities of the plurality of beams irradiated onto respective pixels of the beam detection sensor; and
detecting central positions of the plurality of beams by calculating centers of distributions of the measured intensities of the plurality of beams.

9. The beam position measuring method according to claim 8, wherein the beam expansion device is a diffraction device to diffract the plurality of beams irradiated from the beam generator.

10. The beam position measuring method according to claim 9, wherein the diffraction device is an ultrasonic generator to irradiate ultrasonic waves to diffract the plurality of beams irradiated from the beam generator.

11. The beam position measuring method according to claim 9, wherein the diffraction device is a diffractive optical element to diffract the plurality of beams irradiated from the beam generator.

12. The beam position measuring method according to claim 8, wherein the beam expansion device is a scattering device to scatter the plurality of beams irradiated from the beam generator.

13. The beam position measuring method according to claim 8, wherein the beam detection sensor is a CMOS sensor or a CCD sensor.

14. The beam position measuring method according to claim 7, wherein the beam generator includes at least one of a laser and a laser diode.
